(19) United States
(12) Patent Application Publication
(10) Pub. No.: US 2014/0069244 A1
(43) Pub. Date: Mar. 13, 2014

(54) ALLEVIATING EFFECTS OF PLASTIC FILM DISTORTION IN TOUCH SENSORS

(71) Applicant: APPLE INC., Cupertino, CA (US)

(72) Inventors: Siddharth Mohapatra, Santa Clara, CA (US); Sunggu Kang, San Jose, CA (US); John Z. Zhong, Cupertino, CA (US)

(73) Assignee: Apple Inc., Cupetino, CA (US)

(21) Appl. No.: 13/710,424

(22) Filed: Dec. 10, 2012

Related U.S. Application Data
(60) Provisional application No. 61/699,213, filed on Sep. 10, 2012.

(51) Int. Cl. B26D 7/14; B26D 1/40; B26D 3/00

(52) U.S. Cl. CPC B26D 7/14; B26D 3/00; B26D 1/405
USPC 83/18; 83/13; 83/343; 264/291; 427/314; 427/372.2

(57) ABSTRACT

Systems and processes for die-cutting stretched base films are disclosed. In some examples, the systems can include fixed or adjustable die-cut heads that are offset from one another based on an amount of distortion of the base film. Systems and processes for reducing the amount of distortion or shrinking of base films are also disclosed. In some examples, the processes can include pre-shrinking the base film by exposing the film to elevated temperatures sufficient to shrink the film. The pre-shrinking can be performed on the base film material alone, or can be applied during subsequent annealing stages. The pre-shrinking can be used alone or in combination with the offset die-cutters.

### FIELD

This relates generally to touch sensors and, more specifically, to reducing the effects of film distortion in touch sensor manufacturing processes.

### Background

Many types of input devices are presently available for performing operations in a computing system, such as buttons or keys, mice, trackballs, joysticks, touch sensor panels, touch screens, and the like. Touch sensitive devices, such as touch screens, in particular, are becoming increasingly popular because of their ease and versatility of operation. A touch sensitive device can include a touch sensor panel, which can be a clear panel with a touch-sensitive surface, and a display device, such as a liquid crystal display (LCD) or organic light emitting diode (OLED) display, that can be positioned partially or fully behind the panel so that the touch-sensitive surface can cover at least a portion of the viewable area of the display device. The touch sensitive device can allow a user to perform various functions by touching the touch sensor panel using a finger, stylus, or other object at a location often dictated by a user interface (UI) being displayed by the display device. In general, the touch sensitive device can recognize a touch event and the position of the touch event on the touch sensor panel, and the computing system can then interpret the touch event in accordance with the display appearing at the time of the touch event, and thereafter can perform one or more actions based on the touch event.

Many processes have been developed to manufacture these touch sensors. For example, conventional roll-to-roll processes involve patterning electronic devices onto rolls of thin, flexible plastic or metal foil. These devices can then be removed from the roll using lithography or a physical cutting process. These roll-to-roll processes can reduce the amount of time and money required to manufacture touch sensors. However, when rolls of plastic film are exposed to elevated temperatures, pressures, or chemicals, the films can distort. This can have an adverse effect on the touch sensor manufacturing process and the resulting touch sensors. Thus, improved touch sensor manufacturing systems and processes are desired to alleviate the effects of film distortion.

### SUMMARY

This relates to systems and processes for die-cutting stretched base films. In some examples, the systems can include fixed or adjustable die-cut heads that are offset from one another based on an amount of distortion of the base film. Systems and processes for reducing the amount of distortion or shrinking of base films are also disclosed. In some examples, the processes can include pre-shrinking the base film by exposing the film to elevated temperatures sufficient to shrink the film. The pre-shrinking can be performed on the base film material alone, or can be applied during subsequent annealing stages. The pre-shrinking can be used alone or in combination with the offset die-cutters.

### BRIEF DESCRIPTION OF THE DRAWINGS

FIG. 1 illustrates an exemplary touch sensor according to various examples.

FIG. 2 illustrates an exemplary mother sheet containing multiple touch sensors according to various examples.

FIG. 3 illustrates multiple touch sensors formed on a diagonally stretched base film according to various examples.

FIG. 4 illustrates exemplary offset die-cutter heads being applied to touch sensors formed on a diagonally stretched base film according to various examples.

FIG. 5 illustrates an exemplary process for configuring adjustable die-cutter heads according to various examples.

FIG. 6 illustrates an exemplary process for reducing distortion or shrinking in a base film according to various examples.

FIG. 7 illustrates a diagonally stretched base film containing multiple touch sensors that have been rotated according to various examples.

FIG. 8 illustrates photo-masks and the resulting touch sensors formed on a base film according to various examples.

FIG. 9 illustrates an exemplary system for manufacturing touch sensors according to various examples.

FIGS. 10-13 illustrate exemplary personal devices having a touch sensor manufactured according to various examples.

### DETAILED DESCRIPTION

In the following description of the disclosure and examples, reference is made to the accompanying drawings in which it is shown by way of illustration specific examples that can be practiced. It is to be understood that other examples can be practiced and structural changes can be made without departing from the scope of the disclosure.

Various examples related to systems and processes for die-cutting stretched base films are provided. In some examples, the systems can include adjustable die-cut heads that are offset from one another based on an amount of distortion of the base film. Systems and processes for reducing the amount of distortion or shrinking of base films are also disclosed. In some examples, the processes can include pre-shrinking the base film by exposing the film to elevated temperatures sufficient to shrink the film. The pre-shrinking can be performed on the base film material alone, or can be applied during subsequent annealing stages. The pre-shrinking can be used alone or in combination with the offset die-cutters.

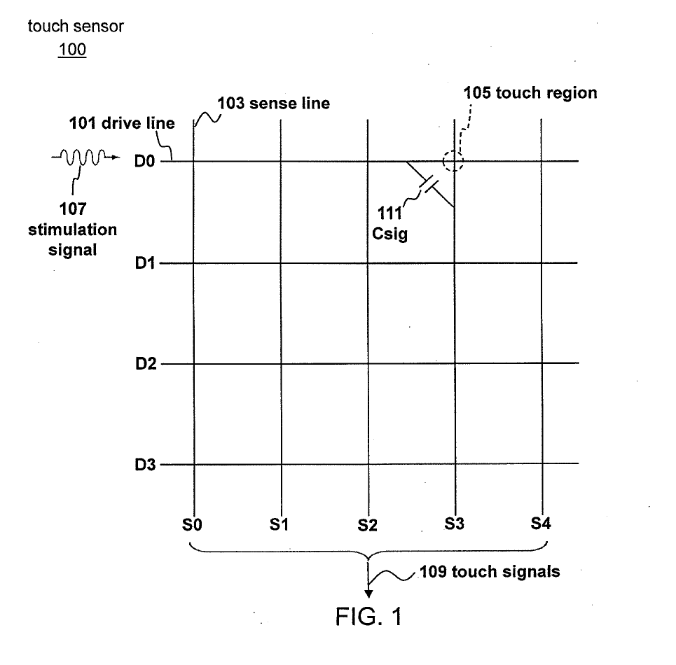

FIG. 1 illustrates touch sensor 100 that can be used to detect touch events on a touch sensitive device, such as a mobile phone, tablet, touchpad, portable computer, portable media player, or the like. Touch sensor 100 can include an array of touch regions or nodes 105 that can be formed at the crossing points between rows of drive lines 101 (D0-D3) and columns of sense lines 103 (S0-S4). Each touch region 105 can have an associated mutual capacitance Csig 111 formed between the crossing drive lines 101 and sense lines 103 when the drive lines are stimulated. The drive lines 101 can be stimulated by stimulation signals 107 provided by drive circuitry (not shown) and can include an alternating current (AC) waveform. The sense lines 103 can transmit touch signals 109 indicative of a touch at the touch sensor 100 to sense circuitry (not shown), which can include a sense amplifier for each sense line, or a fewer number of sense amplifiers that can be multiplexed to connect to a larger number of sense lines.

To sense a touch at the touch sensor 100, drive lines 101 can be stimulated by the stimulation signals 107 to capacitively couple with the crossing sense lines 103, thereby forming a capacitive path for coupling charge from the drive lines 101 to the sense lines 103. The crossing sense lines 103 can output touch signals 109, representing the coupled charge or current. When an object, such as a stylus, finger, etc., touches the touch sensor 100, the object can cause the capacitance Csig 111 to reduce by an amount ΔCsig at the touch location. This capacitance change ΔCsig can be caused by charge or current from the stimulated drive line 101 being shunted through the touching object to ground rather than being coupled to the crossing sense line 103 at the touch location. The touch signals 109 representative of the capacitance change ΔCsig can be transmitted by the sense lines 103 to the sense circuitry for processing. The touch signals 109 can indicate the touch region where the touch occurred and the amount of touch that occurred at that touch region location.

While the example shown in FIG. 1 includes four drive lines 101 and five sense lines 103, it should be appreciated that touch sensor 100 can include any number of drive lines 101 and any number of sense lines 103 to form the desired number and pattern of touch regions 105. Additionally, while the drive lines 101 and sense lines 103 are shown in FIG. 1 in a crossing configuration, it should be appreciated that other configurations are also possible to form the desired touch region pattern. While FIG. 1 illustrates mutual capacitance touch sensing, other touch sensing technologies may also be used in conjunction with examples of the disclosure, such as self-capacitance touch sensing, resistive touch sensing, projection scan touch sensing, and the like. Furthermore, while various examples describe a sensed touch, it should be appreciated that the touch sensor 100 can also sense a hovering object and generate hover signals therefrom.

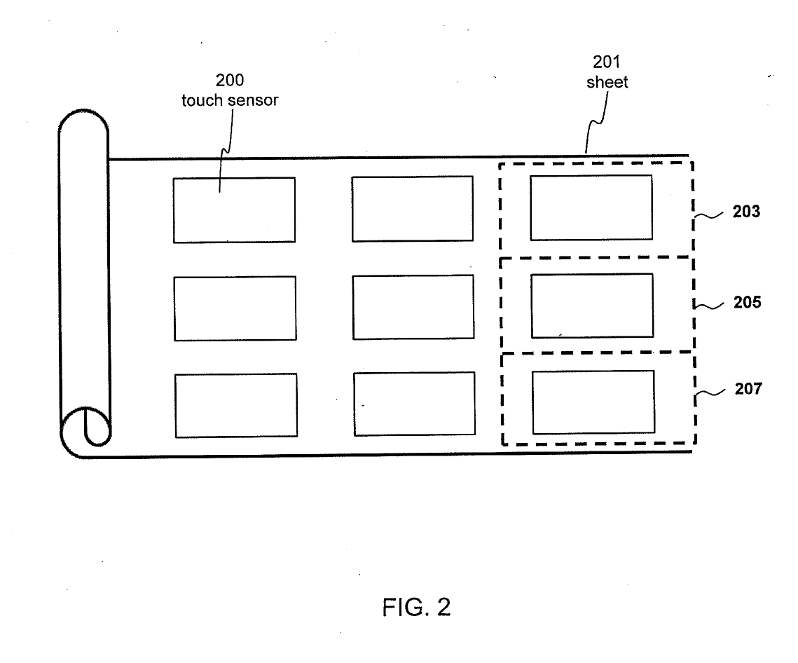

Touch sensors, such as touch sensor 100, can be manufactured in various ways. For example, touch sensors can be manufactured using a roll-to-roll process that involves patterning the touch sensor onto rolls of thin, flexible plastic or metal foil. These devices can then be removed from the roll using lithography or a physical cutting process. To illustrate, FIG. 2 shows multiple touch sensors 200 similar or identical to touch sensor 100 formed on a sheet of base film 201. In some examples, the sheet of base film 201 can include a malleable material or a flexible plastic material, such as cyclo olefin polymer (COP). In these examples, the drive lines, sense lines, bond pads, metal traces, and the like, of the touch sensor 200 can be formed by etching copper and indium tin oxide formed on the COP material. Once the touch sensors 200 are patterned onto the sheet of base film 201, the touch sensors can be cut from the sheet of base film 201, producing individual touch sensors 200. For example, a die-cutter having multiple heads 203, 205, and 207 can be used to simultaneously cut multiple touch sensors 200 from the sheet of base film 201. In the example shown in FIG. 2, the die-cutter can be used to simultaneously cut columns (e.g., groups of three touch sensors 200) of touch sensors 200. However, it should be appreciated that the die-cutter can be configured to have a fewer or greater number of heads depending on the configuration of touch sensors 200 on the sheet of base film 201.

In some examples, prior to forming touch sensors on the sheet of base film 201, the base film 201 can be stretched in various directions to impart desired optical characteristics on the base film 201. For example, stretching of the base film 201 can be performed to form a desired optical axis and retardation value in the base film 201. This can allow the base film 201 to act as a quarter-wave optical retarder, causing the base film 201 to convert the uni-directionally polarized light that is typically emitted from displays of touch sensitive devices into circularly polarized light. By converting the uni-directionally polarized light into circularly polarized light, the stretched base film 201 can mitigate the effect of a reduction in display image quality typically observed when viewing the screen through a polarized filter, such as a pair of polarized sunglasses. A more detailed description of stretching a base film, such as base film 201, to impart desired optical characteristics is provided in U.S. application Ser. No. 13/230,331.

To generate circularly polarized light, the optical axis formed in the sheet of base film 201 should form a 45°±30° or 135°±30° angle with respect to the polarization angle of light emitted from the display of the touch sensitive device in which the base film 201 is incorporated. Thus, a diagonal stretch, such as a stretch at a 45° angle relative to the machine direction (e.g., the direction that the base film 201 travels in the roll-to-roll process), can be performed on the sheet of base film 201.

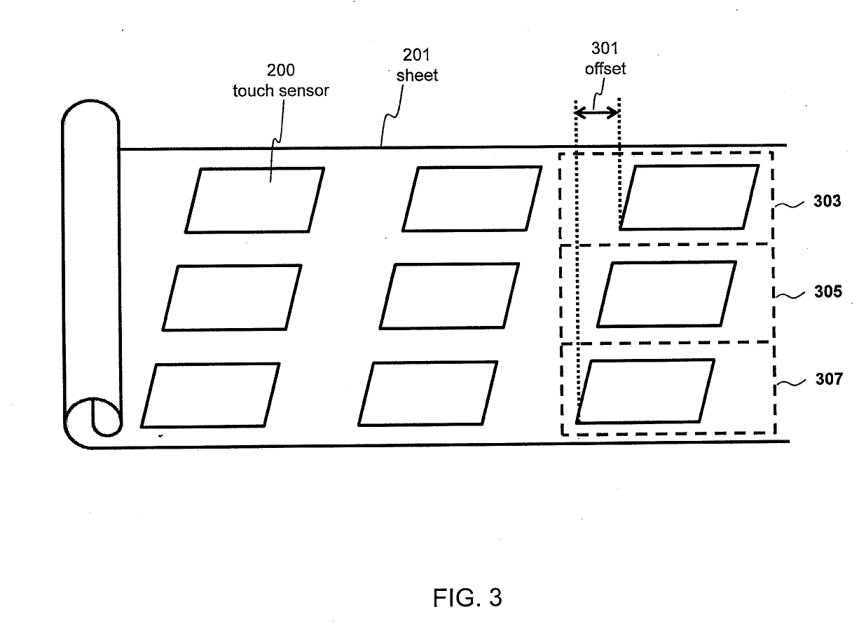

While this type of stretch can impart the desired optical qualities in the base film 201, it can produce difficulties in the roll-to-roll manufacturing process. Specifically, when plastic base films are exposed to elevated temperatures, pressures, or chemicals, the plastic base films can distort or shrink. When a stretched, plastic base film is exposed to elevated temperatures, pressures, or chemicals, the base film can distort in the direction of the stretch. For example, FIG. 3 illustrates touch sensors 200 formed on a sheet of base film 201 that has been diagonally stretched. As a result of the stretch and exposure of base film 201 to elevated temperatures, pressures, or chemicals, the touch sensors 200 have been distorted in the direction of the stretch, resulting in touch sensors 200 having a parallelogram shape. Moreover, the touch sensors 200 may not be vertically aligned as those shown in FIG. 2, since the touch sensors 200 have been stretched in both the machine direction and transverse direction. For instance, an offset distance 301 can be generated between touch sensors 200 at opposite sides of the base film 201. The actual value of offset distance 301 can vary depending on the properties of the base film, conditions that the base film was exposed to, amount of stretch performed on the base film, configuration of the touch sensors on the base film, and the like. However, regardless of the actual value of the offset distance 301, this offset can cause misalignment of touch sensors 200 under each head 303, 305, or 307 of a die-cutter having vertically aligned heads. As a result, the touch sensors 200 may not be uniformly centered within each cut section formed by die-cutter heads 303, 305, and 307. Additionally, larger die-cutter heads may be required to provide necessary clearance distances between the touch sensors 200 and the edges of the cuts performed by the die-cutter heads 303, 305, and 307.

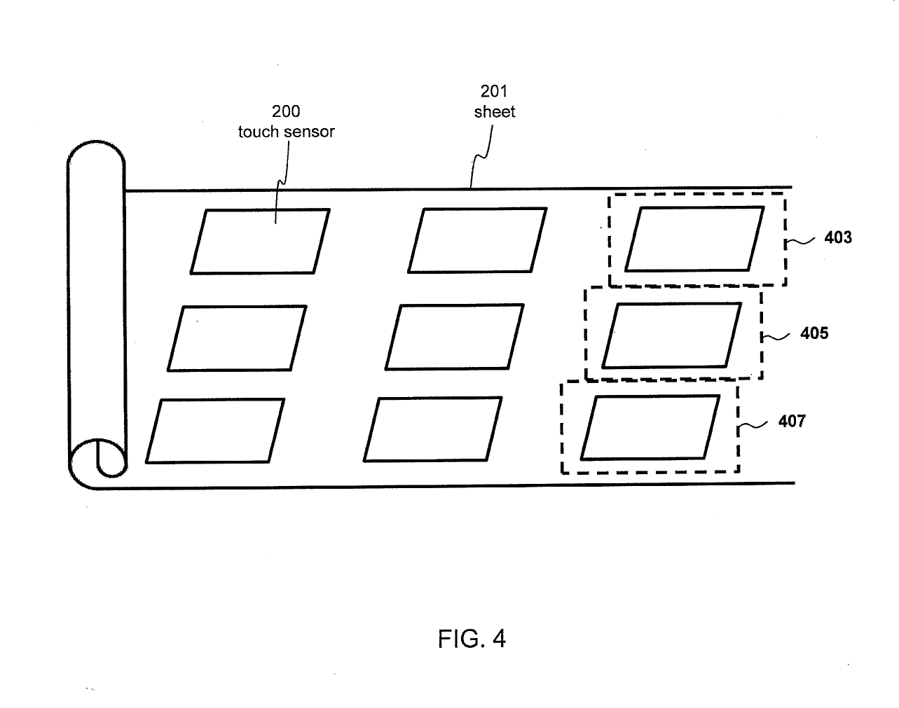

To compensate for the effects of a diagonal stretch described above, a die-cutter having offset die-cutter heads according to various examples of the present disclosure can be used. FIG. 4 illustrates the same touch sensors 200 formed on the diagonally stretched sheet of base film 201 shown in FIG. 3. However, a die-cutter having offset heads 403, 405, and 407 can be used to cut touch sensors 200 from the base film 201. The offset heads 403, 405, and 407 can be offset by an amount corresponding to the offsets between vertically adjacent touch sensors 200. Using an offset die-cutter, multiple touch sensors 200 can be simultaneously cut from the sheet of base film 201 to produce touch sensors 200 that are more uniformly centered within the portions of base film 201 cut by the die-cutter. Additionally, the die-cutter heads 403, 405, and 407 can be smaller than the vertically aligned die-cutter heads 303, 305 and 307 since they do not need to compensate for the offset distance 301. While the example shown in FIG. 4 shows the heads 403, 405, and 407 offset in the machine direction, it should be appreciated that the heads can instead be offset in the transverse direction or both the machine direction and transverse direction.

In some examples, the configuration of heads 403, 405, and 407 may be fixed. In these examples, the offset between each die-cutter head can be configured based on the expected offset between touch sensors 200 on the stretched base film 201. The amount of offset can be determined by forming the touch sensors on the stretched base film 201 and observing the offset distance between touch sensors 200.

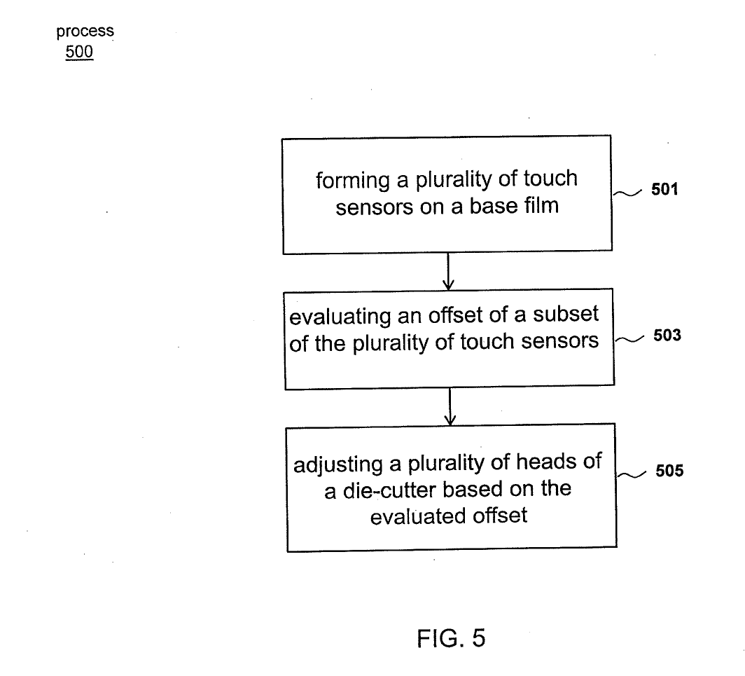

In other examples, the configuration of heads 403, 405, and 407 can be adjustable, allowing the die-cutter to be used in different applications where the offset distance between touch sensors 200 may vary. In these examples, the heads 403, 405, and 407 can be individually moved to properly compensate for the offset between touch sensors 200. FIG. 5 illustrates an exemplary process 500 for configuring the heads of an adjustable offset die-cutter. At block 501, a plurality of touch sensors can be formed on a base film. For example, a plurality of touch sensors similar or identical to touch sensors 200 can be formed on a plastic base film similar or identical to base film 201. The touch sensors can be formed using any known deposition or patterning process. At block 503, an offset can be evaluated between touch sensors of the plurality of touch sensors formed at block 501. In some examples, the subset of touch sensors evaluated at block 503 can include touch sensors corresponding to heads of a die-cutter. For example, the offset between touch sensors in a column corresponding to die-cutter heads similar or identical to die-cutter heads 403, 405, and 407 can be evaluated. At block 507, the adjustable die-cutter heads can be adjusted or moved relative to each other based on the evaluated offsets at block 505. For example, adjustable die-cutter heads similar or identical to die-cutter heads 403, 405, and 407 can be adjusted such that they form cuts in a sheet of base film centered around corresponding touch sensors.

Once calibrated using process 500, touch sensors can be formed on the base film and transported through the manufacturing device using a plurality of rollers. Once complete, an adjustable die-cutter according to various examples can be used to simultaneously cut multiple touch sensors from the sheet of base film. Using this improved adjustable die-cutter head, touch sensors can be cut more uniformly from a stretched base film.

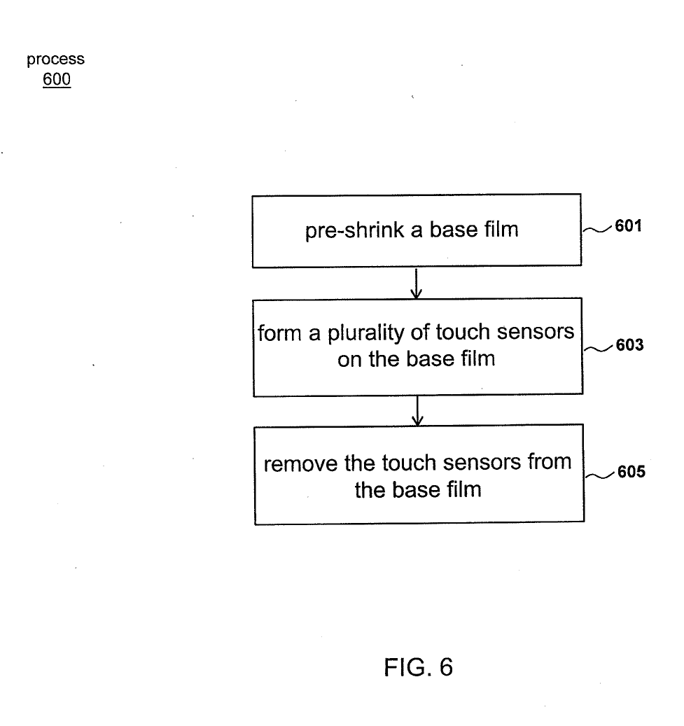

Alternatively or in addition to using the offset die-cutter described above, a pre-shrinking process according to various examples can be used to prevent or reduce the amount of distortion or shrinking experienced by a stretched or un-stretched base film. FIG. 6 illustrates an exemplary touch sensor manufacturing process 600 that includes pre-shrinking of the base film. At block 601, the base film can be put through a pre-shrinking process. In some examples, this can include exposing the base film to elevated temperatures for an extended period of time to cause the base film to distort and shrink. As a result of this process, when the base film is subsequently exposed to elevated temperatures, the amount of distortion or shrinking can be reduced. The temperature and duration of the pre-shrinking process can depend on the material used for the base film and the amount of acceptable shrinking or distortion that can occur in subsequent exposures to elevated temperatures, pressures, or chemicals. The pre-shrinking can be performed at various stages prior to depositing the touch sensors on the base film. For example, the base film including the plastic material, such as COP, can be put through an oven at an elevated temperature for an extended period of time after the sheet of plastic material is formed. The elevated temperature and period of time can be sufficient to cause the base film to shrink. In another example, a hard-coat and index matching layer can be deposited on the sheet of plastic film, such as COP. The hard-coat and index matching layer can then be put through an annealing process. In these examples, the pre-shrinking process of block 601 can be performed by extending the annealing period. For example, if the normal annealing process takes 90 seconds, the annealing process can instead be extended to 180 seconds, for example. It should be appreciated that many variations to the temperature, duration, and stage at which the pre-shrinking is performed can be used. One of ordinary skill, given this disclosure, can calculate or experimentally determine acceptable parameters to produce a sufficient level of pre-shrinking that will result in an acceptable amount of shrinking or distortion when the sheet is subsequently exposed to elevated temperatures, pressures, or chemicals.

At block 603, the base film that went through the pre-shrinking process at block 601 can be used as a base film for forming a plurality of touch sensors. For example, touch sensors similar or identical to touch sensors 200 can be formed on the pre-shrunk base film using any known deposition or patterning processes. As a result of the pre-shrinking at block 601, the amount of shrinking or distortion in the base film after forming the plurality of touch sensors at block 605 can be reduced.

At block 605, the touch sensors can be removed from the base film using lithography or a physical cutting process. In one example, an offset die-cutter similar or identical to that described above with respect to FIG. 5 can be used. However, since the base film has been pre-shrunk, the amount of offset needed in the heads of the die-cutter can be reduced.

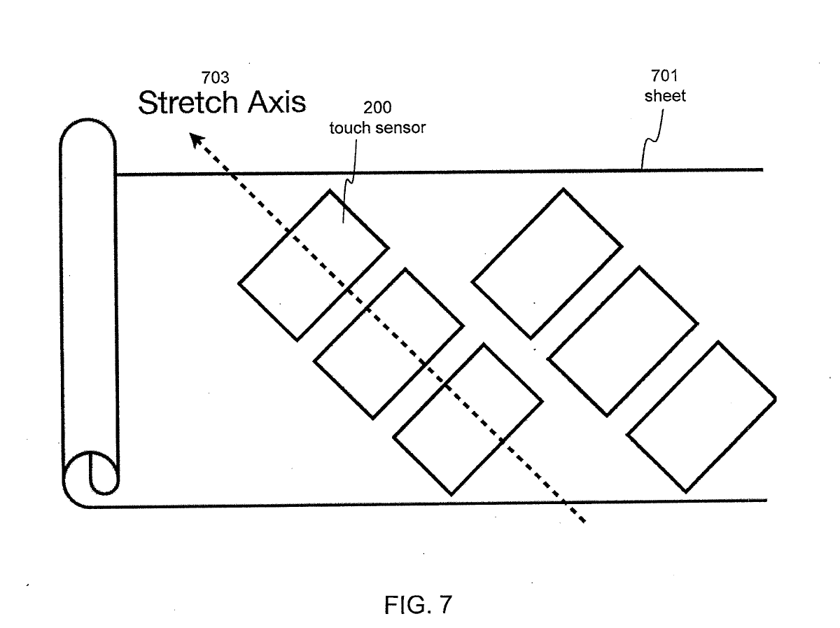

FIG. 7 shows a diagonally stretched sheet of base film 701, similar to those described above, to illustrate a process that can be used to compensate for distortion or shrinking in diagonally stretched base films. In the illustrated example, the touch sensors 200 can be formed on the sheet of base film 701 at an angle corresponding to the stretch axis 703 of the base film 701. For example, the touch sensors can be horizontally or vertically aligned with the stretch axis 703. By forming touch sensors at this angle, the diagonal distortion of base film 701 can result in a distortion of the touch sensors 200 in a vertical and horizontal direction (relative to the orientation of the touch senor, not the base film). The touch sensors 200 can then be cut or removed from the sheet of base film 701 at the angle corresponding to the stretch axis 703 of the base film 701.

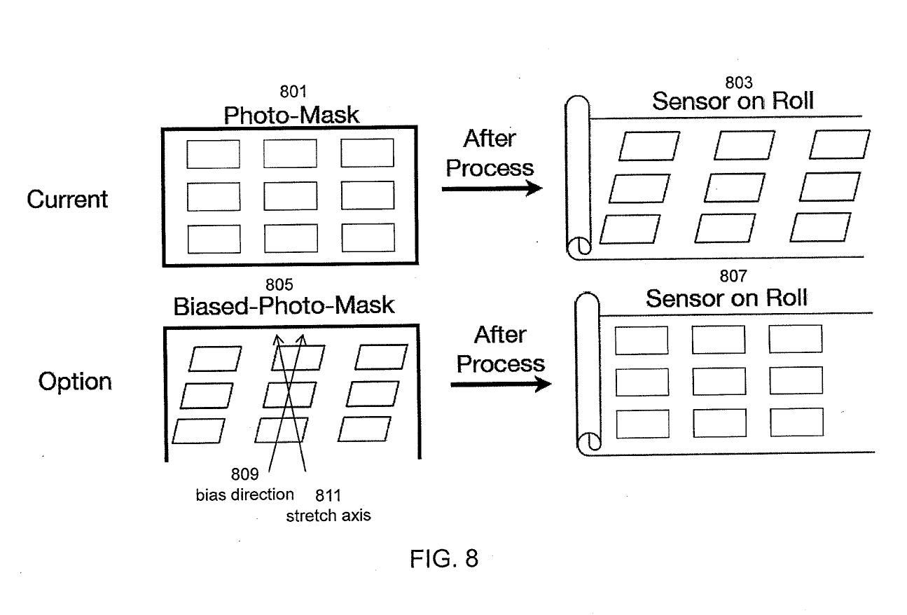

FIG. 8 shows photo-masks and the resulting touch sensors formed on a diagonally stretched base film when the photo-masks are used. In particular, when an unbiased photo-mask 801 is used to form/etch touch sensors on a diagonally stretched sheet of base film, touch sensors can be stretched diagonally as shown in sensor on roll 803. To compensate for the diagonal stretching, the photo-mask can be biased in a direction opposite to the stretch axis or expected direction of distortion of the diagonally stretched base film. This can be done to compensate for the distortion of the base film during/after processing. For example, biased-photo-mask 805 can be used to faun/etch touch sensors on a diagonally stretched sheet of base film to form vertically (or at least close to vertically) aligned touch sensors as shown by sensor on roll 807. In particular, if the sheet of base film has a stretch axis 811, the photo-mask 805 can have a bias direction 809.

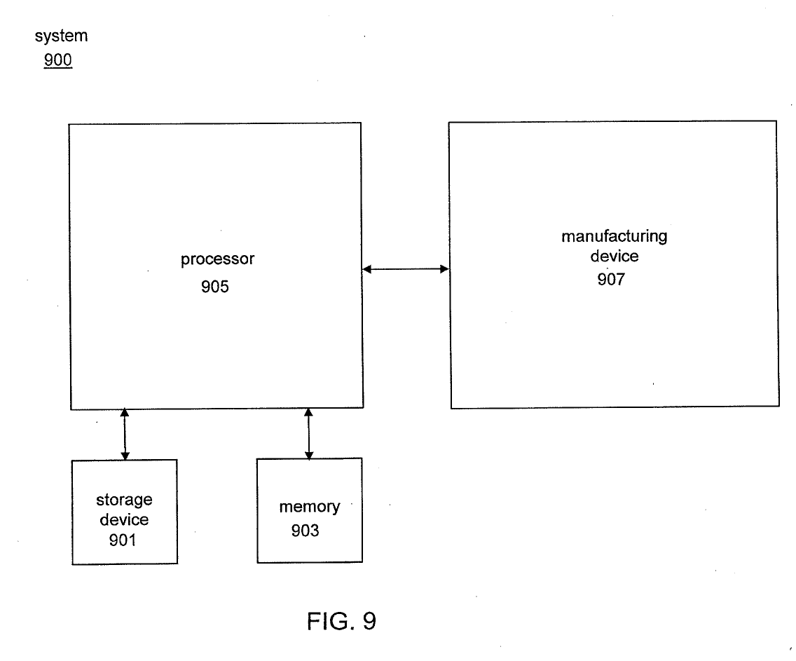

One or more of the functions relating to the manufacturing of a touch sensitive device described above can be performed by a system similar or identical to system 900 shown in FIG. 9. System 900 can include instructions stored in a non-transitory computer readable storage medium, such as memory 903 or storage device 901, and executed by processor 905. The instructions can also be stored and/or transported within any non-transitory computer readable storage medium for use by or in connection with an instruction execution system, apparatus, or device, such as a computer-based system, processor-containing system, or other system that can fetch the instructions from the instruction execution system, apparatus, or device and execute the instructions. In the context of this document, a “non-transitory computer readable storage medium” can be any medium that can contain or store the program for use by or in connection with the instruction execution system, apparatus, or device. The non-transitory computer readable storage medium can include, but is not limited to, an electronic, magnetic, optical, electromagnetic, infrared, or semiconductor system, apparatus or device, a portable computer diskette (magnetic), a random access memory (RAM) (magnetic), a read-only memory (ROM) (magnetic), an erasable programmable read-only memory (EPROM) (magnetic), a portable optical disc such a CD, CD-R, CD-RW, DVD, DVD-R, or DVD-RW, or flash memory such as compact flash cards, secured digital cards, USB memory devices, memory sticks, and the like.

The instructions can also be propagated within any transport medium for use by or in connection with an instruction execution system, apparatus, or device, such as a computer-based system, processor-containing system, or other system that can fetch the instructions from the instruction execution system, apparatus, or device and execute the instructions. In the context of this document, a “transport medium” can be any medium that can communicate, propagate or transport the program for use by or in connection with the instruction execution system, apparatus, or device. The transport medium can include, but is not limited to, an electronic, magnetic, optical, electromagnetic or infrared wired or wireless propagation medium.

System 900 can further include manufacturing device 907 coupled to processor 905. Manufacturing device 907 can include an offset die-cutter similar or identical to that described above with respect to FIG. 5. In some examples, manufacturing device 907 can further include an oven or other heating device to pre-shrink a base film in a manner similar or identical to that described above with respect to FIG. 6. In other examples, the pre-shrinking device can be separate from manufacturing device 907. Processor 905 can control manufacturing device 907 and its components to generate touch sensors and pre-shrunk base films in a manner similar or identical to that described above.

It is to be understood that the system is not limited to the components and configuration of FIG. 9, but can include other or additional components in multiple configurations according to various examples. Additionally, the components of system 900 can be included within a single device, or can be distributed between two manufacturing device 907, in some examples, processor 905 can be located within manufacturing device 907.

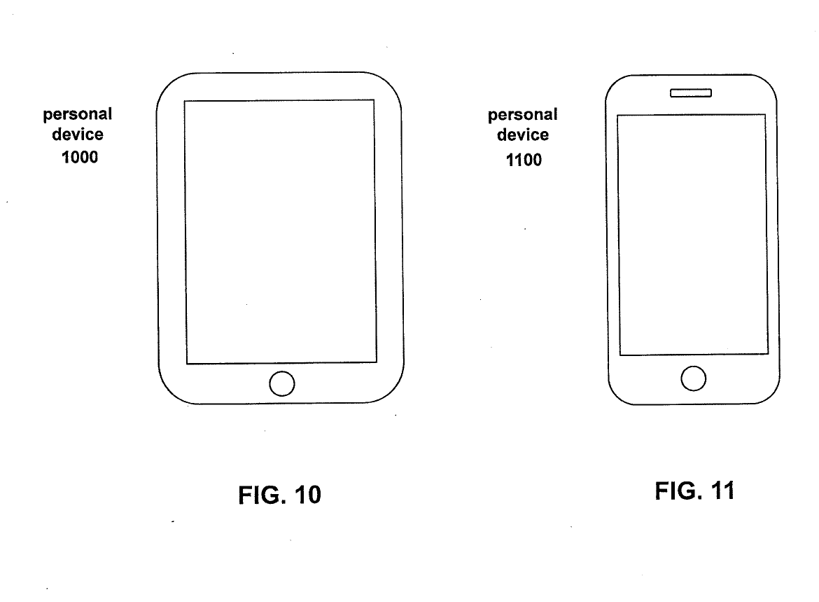

FIG. 10 illustrates an exemplary personal device 1000, such as a tablet, that can include a touch sensor manufactured using the processes described above.

FIG. 11 illustrates another exemplary personal device 1100, such as a mobile phone, that can include a touch sensor manufactured using the processes described above.

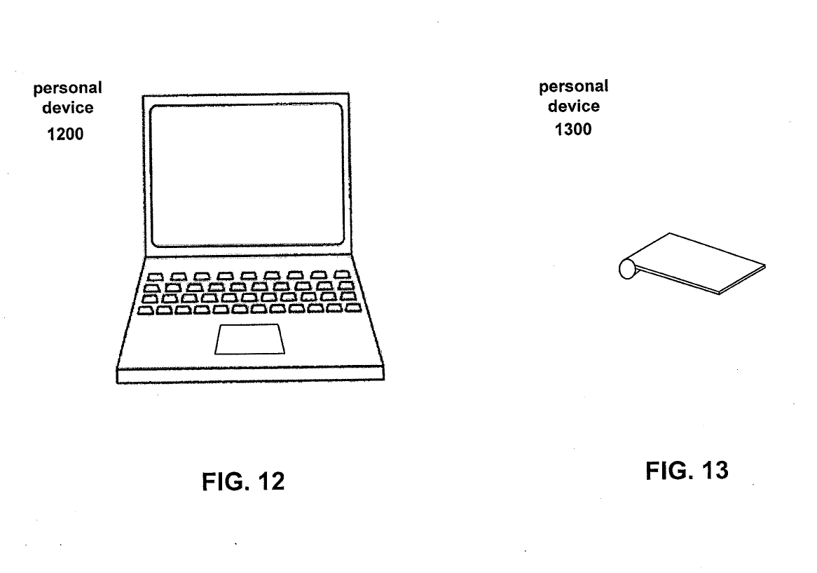

FIG. 12 illustrates an exemplary personal device 1200, such as a laptop having a touchpad that can include a touch sensor manufactured using the processes described above.

FIG. 13 illustrates another exemplary personal device 1300, such as a touch pad, that can include a touch sensor manufactured using the processes described above.

Therefore, according to the above, some examples of the disclosure are directed to a method comprising: forming a plurality of touch sensors on a sheet of base film; transporting the sheet of base film through a plurality of rollers; and cutting the plurality of touch sensors from the sheet of base film using a die-cutter, wherein the die-cutter comprises a plurality of die-cut heads that are offset in a direction parallel to a motion of the sheet of base film through the plurality of rollers. Additionally or alternatively to one or more of the examples disclosed above, the plurality of die-cut heads can comprise a number of heads corresponding to a number of touch sensors in each column on the sheet of base film. Additionally or alternatively to one or more of the examples disclosed above, the sheet of base film may have been stretched prior to the forming of the plurality of touch sensors. Additionally or alternatively to one or more of the examples disclosed above, the sheet of base film may have been stretched at an angle of 45 degrees relative to the direction of the motion of the sheet of base film through the plurality of rollers. Additionally or alternatively to one or more of the examples disclosed above, the method may further comprise diagonally stretching the sheet of base film. Additionally or alternatively to one or more of the examples disclosed above, the method may further comprise, after diagonally stretching the sheet of base film an before forming the plurality of touch sensors on the sheet of base film, exposing the sheet of base film to an elevated temperature sufficient to shrink the sheet of base film.

Some examples of the disclosure are directed to an apparatus comprising: a plurality of rollers operable to transport a sheet of base film through the apparatus; and a die-cutter comprising a plurality of offset die-cut heads. Additionally or alternatively to one or more of the examples disclosed above, the plurality of offset die-cut heads can be offset in a direction parallel to a motion of the sheet of base film through the plurality of rollers. Additionally or alternatively to one or more of the examples disclosed above, the plurality of offset die-cut heads can be adjustable. Additionally or alternatively to one or more of the examples disclosed above, the plurality of offset die-cut heads can be adjustable in a direction parallel to a motion of the sheet of base film through the plurality of rollers. Additionally or alternatively to one or more of the examples disclosed above, the plurality of offset die-cut heads can be further adjustable in a direction perpendicular to the motion of the sheet of base film through the plurality of rollers.

Some examples of the disclosure are directed to a method comprising: exposing a sheet base film to a temperature sufficient to shrink the base film, wherein the exposing is performed prior to patterning the base film to form a touch sensor. Additionally or alternatively to one or more of the examples disclosed above, the sheet of base film can comprise a diagonally stretched sheet of base film. Additionally or alternatively to one or more of the examples disclosed above, the sheet of base film can comprise cyclo olefin polymer. Additionally or alternatively to one or more of the examples disclosed above, the exposing can be performed prior to depositing a hard-coat layer and an index matching layer on the sheet of base film. Additionally or alternatively to one or more of the examples disclosed above, the exposing can be performed during an annealing processes after a hard-coat layer and an index matching layer has been deposited on the sheet of base film.

Some examples of the disclosure are directed to a method comprising: depositing a hard coat layer on a substrate; depositing an index matching layer on the hard coat layer; and annealing the substrate, hard coat layer, and index matching layer at a temperature sufficient to reduce a size of the substrate. Additionally or alternatively to one or more of the examples disclosed above, the substrate can comprise a sheet of cyclo olefin polymer. Additionally or alternatively to one or more of the examples disclosed above, the substrate can comprise a sheet of diagonally stretched base film. Additionally or alternatively to one or more of the examples disclosed above, the method can further comprise: forming a plurality of touch sensors on the substrate; and cutting the plurality of touch sensors from the substrate using a die-cutter, wherein the die-cutter comprises a plurality of offset die-cut heads.

Although the disclosure and examples have been fully described with reference to the accompanying drawings, it is to be noted that various changes and modifications will become apparent to those skilled in the art. Such changes and modifications are to be understood as being included within the scope of the disclosure and examples as defined by the appended claims.

What is claimed is:

1. A method comprising:
forming a plurality of touch sensors on a sheet of base film;
transporting the sheet of base film through a plurality of rollers; and
cutting the plurality of touch sensors from the sheet of base film using a die-cutter, wherein the die-cutter comprises a plurality of die-cut heads that are offset in a direction parallel to a motion of the sheet of base film through the plurality of rollers.

2. The method of claim 1, wherein the plurality of die-cut heads comprises a number of heads corresponding to a number of touch sensors in each column on the sheet of base film.

3. The method of claim 1, wherein the sheet of base film has been stretched prior to the forming of the plurality of touch sensors.

4. The method of claim 1, wherein the sheet of base film has been stretched at an angle of 45 degrees relative to the direction of the motion of the sheet of base film through the plurality of rollers.

5. The method of claim 1, wherein the method further comprises diagonally stretching the sheet of base film.

6. The method of claim 5, wherein the method further comprises, after diagonally stretching the sheet of base film an before forming the plurality of touch sensors on the sheet of base film, exposing the sheet of base film to an elevated temperature sufficient to shrink the sheet of base film.

7. An apparatus comprising:
a plurality of rollers operable to transport a sheet of base film through the apparatus; and
a die-cutter comprising a plurality of offset die-cut heads.

8. The apparatus of claim 7, wherein the plurality of offset die-cut heads are offset in a direction parallel to a motion of the sheet of base film through the plurality of rollers.

9. The apparatus of claim 7, wherein the plurality of offset die-cut heads are adjustable.

10. The apparatus of claim 9, wherein the plurality of offset die-cut heads are adjustable in a direction parallel to a motion of the sheet of base film through the plurality of rollers.

11. The apparatus of claim 10, wherein the plurality of offset die-cut heads are further adjustable in a direction perpendicular to the motion of the sheet of base film through the plurality of rollers.

12. A method comprising:
exposing a sheet base film to a temperature sufficient to shrink the base film, wherein the exposing is performed prior to patterning the base film to form a touch sensor.

13. The method of claim 12, wherein the sheet of base film comprises a diagonally stretched sheet of base film.

14. The method of claim 12, wherein the sheet of base film comprises cyclo olefin polymer.

15. The method of claim 14, wherein the exposing is performed prior to depositing a hard-coat layer and an index matching layer on the sheet of base film.

16. The method of claim 12, wherein the exposing is performed during an annealing processes after a hard-coat layer and an index matching layer has been deposited on the sheet of base film.

17. A method comprising:
depositing a hard coat layer on a substrate;
depositing an index matching layer on the hard coat layer; and
annealing the substrate, hard coat layer, and index matching layer at a temperature sufficient to reduce a size of the substrate.

18. The method of claim 17, wherein the substrate comprises a sheet of cyclo olefin polymer.

19. The method of claim 17, wherein the substrate comprises a sheet of diagonally stretched base film.

20. The method of claim 19, wherein the method further comprises:
forming a plurality of touch sensors on the substrate; and
cutting the plurality of touch sensors from the substrate using a die-cutter, wherein the die-cutter comprises a plurality of offset die-cut heads.
